(19) United States
(12) Patent Application Publication
(10) Pub. No.: US 2006/0231783 A1
(43) Pub. Date: Oct. 19, 2006

(54) Valve drive for a gas exchange valve

(75) Inventor: Peter Volz, In den Wingerten (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG, Frankfurt (DE)

(21) Appl. No.: 10/558,464

(22) PCT Filed: Mar. 29, 2004
(86) PCT No.: PCT/EP04/50387

§ 371 Date: Nov. 28, 2005

(30) Foreign Application Priority Data
May 26, 2003 (DE) 103 23 657.0
Sep. 10, 2003 (DE) 103 41 698.6

(51) Int. Cl. F16K 31/02

(52) U.S. Cl. 251/129.11

(57) ABSTRACT

The present device relates to a valve drive for a gas exchange valve (11) in a power engine or a processing machine. The device includes a magnetic rotor (12) which extends in a longitudinally movable manner with a rotor section. The rotor section may be hollow and cylindrical and is positioned at a distance from the gas exchange valve (11), within a stator (1). The stator is provided with a current coil (23), so that one end of the rotor (12) projects out from the stator (1), upon the stimulation of the current coil (23), and activates the gas exchange valve (11). The rotor (12), along with the stator (1), forms a structural component which is independently operable and can preferably be functionally inspected in advance, which is detachably connected with the gas exchange valve (11).

### BACKGROUND OF THE INVENTION

The invention relates to a valve drive for a gas exchange valve having a stator with a current coil and a magnetic rotor which activates the gas exchange valve when the current coil is activated.

A whole series of valve drives of the type stated is known from the patent literature. In this connection, reference is hereby made to DE 101 25 767 C1.

The basic principle of this valve drive, which is already known from this patent, is that a rotor rigidly connected with the gas exchange valve is moved along the common axis in the magnetic field of a stator.

In order to produce sufficiently high forces on the rotor in an economical manner, correspondingly strong magnetic fields are needed in the air gap between the stator and the rotor. For this purpose, the air gaps in the magnetic circuit must be as small as possible, and suitable current coils must be positioned on the stator, among other features.

Furthermore, the actuator, which consists of the stator and the rotor, must fit into the relatively small construction spaces that are available, such as the cylinder head of a motor vehicle internal combustion engine, for example, for which reason the current coils and the active air gap surfaces can not be constructed as large as desired. The magnetic losses in the magnetic circuit must be kept low. In addition, the current and voltage are limited, even in the on-board power system of motor vehicles.

In the complex geometries on a cylinder head of an internal combustion engine, very exacting geometric tolerances must be observed between the individual function elements, particularly between the rotor and the stator of the valve drive, in order to prevent a jamming or an excessively large air gap.

Moreover, asymmetrical magnetic fields in the air gap on the rotor lead to considerable transverse forces, which are reinforced and can lead to excessively great frictional forces, energy losses, and even to the jamming of the rotor that has already been mentioned.

Since considerable temperature differences have to be taken into account on all engine components during the heating and cooling phase, especially in the case of internal combustion engines, and thereby thermally-induced changes in geometry as well (in the case of components made from materials with different thermal expansions and sharply differing temperatures), the air gaps and clearances must, for thermal reasons, be kept sufficiently large, particularly in the valve drive.

Accelerations of up to 100 times acceleration due to gravity act on gas exchange valves. These lead to excessively large component clearances and, in the air gap of the magnetic circuit, to an undesirable development of noise, asymmetrical forces, and abrasion in the valve drive.

In addition, particles from abrasion, wear and dirt, which are sometimes even magnetic, are always present in an internal combustion engine. These particles can also collect in the magnetic gaps of the actuator and lead to the jamming of the valve drive.

The connection of a gas exchange valve with the valve drive represents a considerable technical manufacturing problem, both in a working machine as well as in a driving engine. That is to say, because of the local and functional conditions, the inspectability, the assembly and the disassembly of the gas exchange valve and of the valve drive in the cylinder head must be guaranteed independently of one another.

### SUMMARY OF THE INVENTION

Thus, the task of the present invention is to improve a valve drive of the type stated above in such a manner that the above-stated requirements are fulfilled and the disadvantages noted are avoided.

In accordance with the invention, this task is solved for a valve drive of the type stated by means of a valve drive for a gas exchange valve having a stator with a current coil and a magnetic rotor which activates the gas exchange valve when the current coil is activated.

### BRIEF DESCRIPTION OF THE DRAWINGS

Additional characteristics, advantages, and possibilities for the use of the invention emerge in the following from the description of one example of implementation, as well as several diagrams.

These depict the following:

FIG. 1: A cross-section through a cylinder head in which a valve drive with a coupling element in accordance with the invention is positioned;

FIG. 2: A schematic view of the valve drive in accordance with the invention depicted in cross-section in FIG. 1, but without the coupling element;

FIG. 3: The valve drive in accordance with FIG. 2 in the area of the horizontal cutting plane B-B;

FIG. 4a: The valve drive in accordance with FIG. 2 in the area of the horizontal cutting plane A-A;

FIG. 4b: A three-dimensional representation of the rotor with external guide elements;

FIG. 4c: A three-dimensional representation of the rotor with internal guide elements;

FIGS. 5a-e: Several variants of the coupling element for the detachable placement of the gas exchange valve on the valve drive.

### DETAILED DESCRIPTION OF THE DRAWINGS

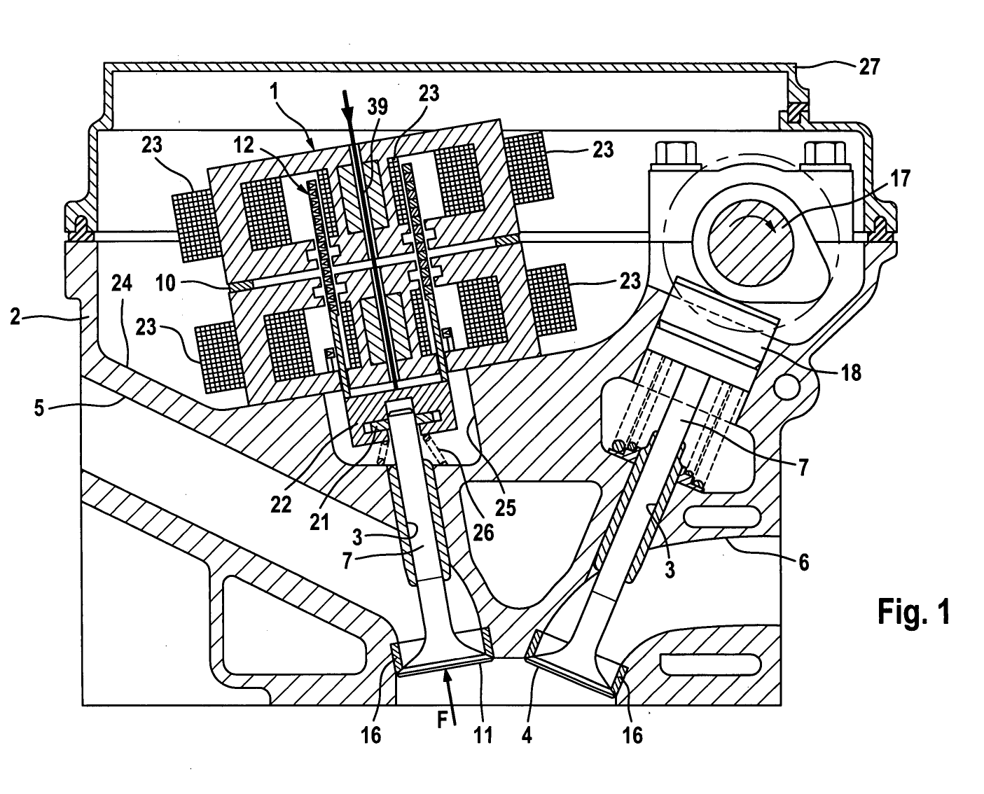

FIG. 1 depicts the arrangement of a valve drive in the cylinder head 2 of an internal combustion engine for the purpose of the activation of the gas exchange valve 11 positioned on the intake end. For this purpose, the cylinder head 2 depicted in cross-section has a first valve accommodation boring 3 for guiding and sealing off the gas exchange valve 11 on the intake side and a second valve accommodation boring 3 for a gas exchange valve 4 on the outlet side, which are both positioned at a “V” angle to one another. The gas exchange valves 4, 11 are designed as disk valves that are oriented concentrically, along with their valve seat surfaces, towards the valve seat rings 16 placed in the intake and outlet channels 5, 6. In the present example, the intake and outlet channels 5, 6 are operated in accordance with transverse flow technology, while the gas exchange valves 4, 11 are operated in accordance with the OHC (Over-Head Camshaft) principle.

A conventional valve drive 4, in the form of a camshaft 17, the cam of which acts on the valve shaft 7 of the gas exchange valve 4 on the outlet side by way of a tappet 18, is correspondingly located above the gas exchange valve 4 on the outlet side.

In contrast to that, an electromagnetic actuator, inside the stator 1 of which an axially movable rotor 12 is positioned and which is detachably connected with the valve shaft 7 of the gas exchange valve 11 on the intake side by way of a coupling element 22, is positioned as a valve drive above the gas exchange valve 11 on the intake side. This valve drive, which has been designed as a linear motor, guarantees a variable gas exchange in which the valve stroke, as well as the valve opening time of the gas exchange valve 11 on the intake side, can be adjusted as desired in dependence on the triggering of a current coil 23 in the stator 1 at the point in time of the opening of the valve.

The conventional valve drive provided for the outlet valve can obviously also be replaced by the actuator described for the intake valve, depending on the desire or need.

The invention provides that the rotor 12, along with the stator 1, forms a structural component which is independently operable and can preferably be functionally inspected in advance, and which is detachably connected with the gas exchange valve 11. The coupling element 22 positioned between the rotor 12 and the gas exchange valve 11, which produces a force-locking and/or form-locking connection between the rotor 12 and the gas exchange valve 11, is necessary for this purpose.

As is evident from FIG. 1, the stator 1 with the rotor 12, and the coupling element 22 attached to the rotor 12, are coaxially aligned with and attached to the gas exchange valve 11 in the cylinder head 2. In order to keep the projection of the valve drive on the cylinder head 2 as small as possible, the cylinder head has a cavity 24, in which the stator 1 is attached above the gas exchange valve 11 on the intake side. Furthermore, for the space-saving integration of the coupling element 22 between the valve accommodation boring 3 (valve shaft guide) of the gas exchange valve 11 on the intake side and the cavity 24, a gradated boring 25 is provided in the cylinder head 2. An auxiliary spring 26 is located between the coupling element 22 and the base of the gradated boring 25 in order, in the event of a failure of the current coil 23, to be able to securely close the gas exchange valve 11 again in order to prevent contact with the piston. The stator 1 and the valve drive on the cam side are covered by a cylinder head cover 27 attached to the cylinder head 2.

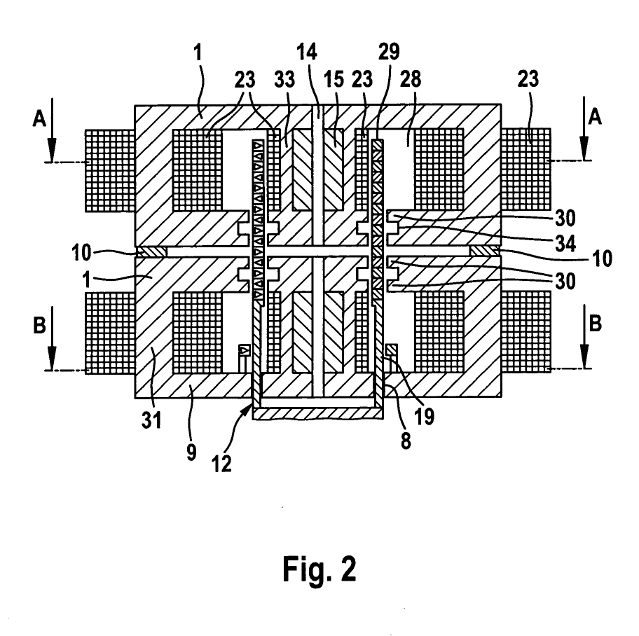

The additional details of the valve drive, which is designed as a linear motor, will be explained in further detail in the following by means of FIGS. 2-5.

FIG. 2 depicts the valve drive in accordance with the invention depicted in FIG. 1, which valve drive consists of a magnetic rotor 12 which extends, with its preferably hollow cylindrical rotor section positioned at a distance from the gas exchange valve 11 on the intake side, in a longitudinally movable manner inside a rotor 1 provided with the current coil 23, whereby one end of the rotor 12 projecting out from the rotor at the bottom activates the gas exchange valve 11 upon the excitation of the current coil 23 by means of the coupling element 22, which is not depicted here. The stator 1 consists of a magnetic material with a radial internal area and a radial external area. The stator boring 14 and the stator core 15, which is enclosed by the internal current coil 23, are located in the internal area. In parallel with that, an additional external current coil 23 is located in the external area of the stator 1. Both current coils 23 are positioned radially inside a stator coil chamber 28 at a distance from one another in such a manner that an essentially hollow cylindrical rotor section is positioned in an axially movable manner between the two current coils 23. This rotor section is provided with several magnetic rings 29 which are positioned concentrically one on top of the other and have an alternating magnetic orientation. The magnetic rings 29 are positioned in a radial air gap between an internal and an external toothed area 30 of the stator 1, which has two circular cylindrically rotating teeth aligning with one another and oriented to the magnetic rings 29. The arrangement selected guarantees, independently of the number of the teeth, that the magnetic rings 29 always align with the assigned teeth with the same magnetic orientation.

Since the magnetic rings 29 can only be magnetized with differing polarities with difficulty, it is recommended to use individual magnet segments, which are easy to manufacture or to magnetize and which are positioned one behind the other on the rotor 12 in a ringed configuration, instead of the magnetic rings 29. The rotor 12 is preferably made from a plastic or from a composite material, for which purpose a combination of plastic materials with non-magnetic metals is particularly well suited.

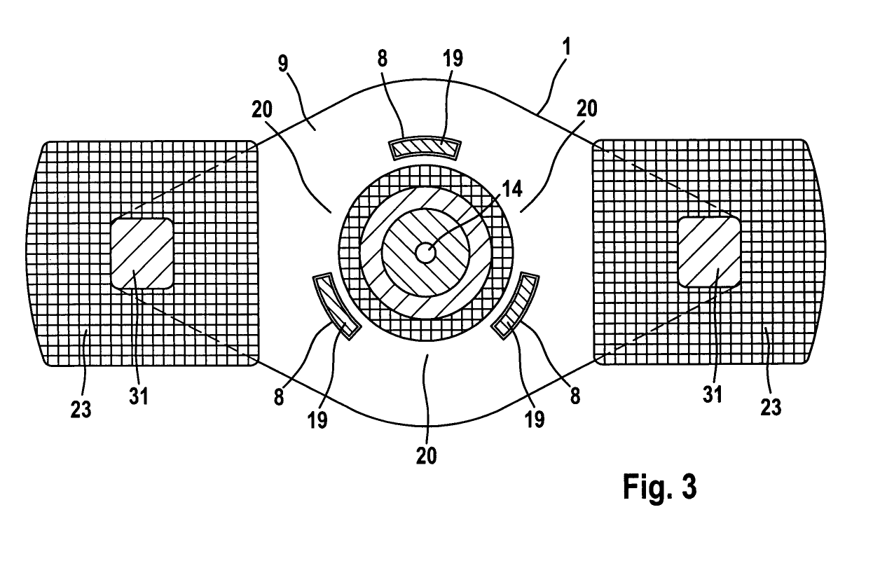

The construction of the stator 1 described above is present with the current coils 23 in a duplex construction form and preferably in a tandem arrangement, so that two stators 1 of identical construction are positioned with their toothed areas 30 oriented towards one another and one above the other in an aligning manner. A plate-shaped, non-magnetic spacer 10, which impedes the unwanted reciprocal magnetic influencing of both stators 1, is positioned between the two stators 1. The lower first end area of the one stator 1, which is oriented towards the valve side, thus only differs from the stator 1 placed above it through the vertically oriented aperture (bushings 8) in the base frame 9, through which the rotor 12, with its magnetic ring, extends into the stator coil chamber 28. This plane, depicted along the transverse line B-B in the lower area of the stator 1, will be illustrated in further detail in the following by means of FIG. 3.

FIG. 3 depicts a view from above of the stator 1, along the transverse line B-B indicated in FIG. 2, from which the configuration of the aperture in the form of segmental apertures in the first end area of the stator 1, which is oriented towards the gas exchange valve 11, is evident. In this first end area of the stator 1, the apertures mentioned above are functionally configured as three bushings 8, through which three rotor bars 19 positioned on the rotor 12 extend. The bushings 8 and the rotor bars 19 are positioned distributed at a uniform angular spacing over the circumference of the stator 1 in such a manner that the bushings 8 provided for the rotor bars 19 are spaced from one another by means of several connecting bars 20 of the stator 1 conducting the magnetic flux. The cross-sectional surface of each connecting bar 20 is hereby sensibly selected to be larger than the cross-section of the aperture of every bushing 8, in order to bring about a gain in magnetically conductive stator material relative to the state of the art or, as the case may be, in order to keep the magnetic losses arising from the necessary aperture in the base frame 9 as low as possible.

In the present example of implementation, the stator 1 has an essentially oval shape, which is made particularly clear from the depiction of the stator 1 in the view from above in accordance with FIG. 3. Both of the current coils 23 positioned diametrically opposite to one another on the external area of the stator 1 can be equally well recognized in FIG. 3 as coil winding packets, through which the vertically-oriented connecting frame 31 (easily recognizable already from FIG. 2) extends to the horizontally-proceeding branches of the stator 1, which have the toothed area 30 already mentioned above.

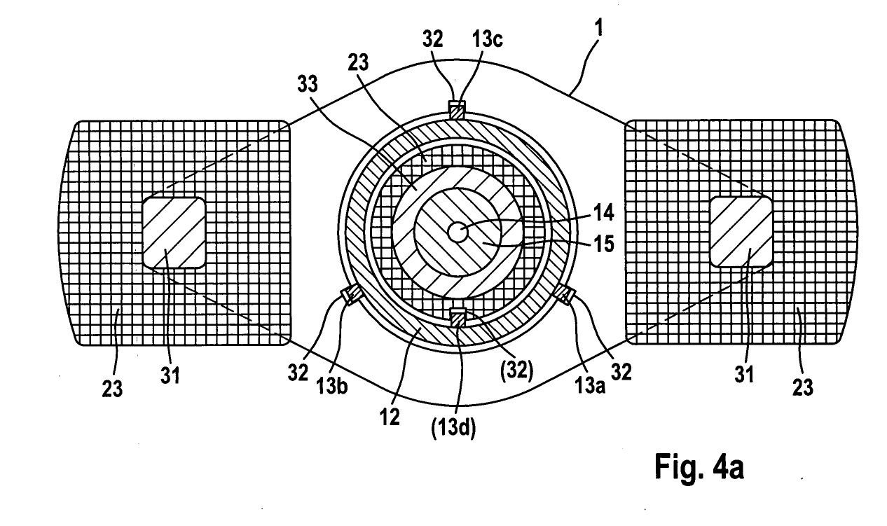

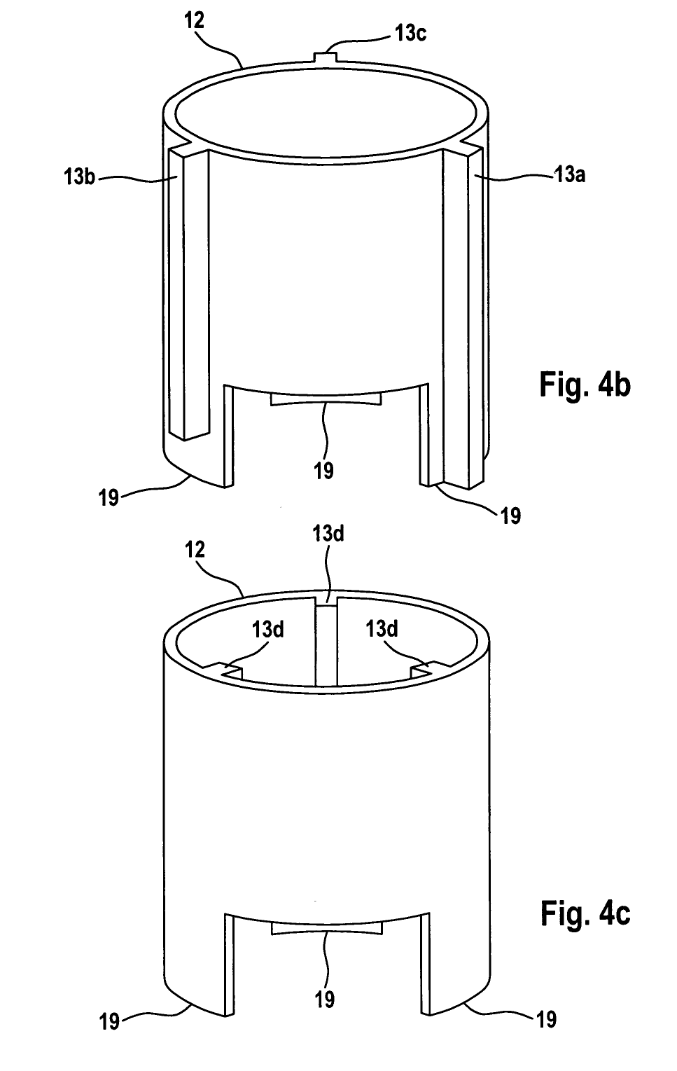

An additional view from above of a profile section of the stator 1 in accordance with FIG. 4-a will now be illustrated in further detail in reference to the transverse line A-A in accordance with FIG. 2.

FIG. 4-a depicts the additional stator 1, positioned above the stator 1 described previously, which [additional stator] is positioned at a distance from the gas exchange valve 11 and at a distance from the first end area of the lower stator 1. This additional stator 1 has several additional guide elements 13a, 13b, 13c, which are positioned distributed uniformly over the external-, or even over the internal-, circumference of the rotor 12 (see, by way of example, one of the three guide elements 13d) inside the stator 1, and which are attached, at least in sections, to the external- or internal circumference of the rotor 12. The three guide elements 13a, 13b, 13c are, in accordance with the diagram, guided into three grooves 32 of the stator 1, whereby the groove depth in the grooves 32 is selected to be considerably greater than the depth of immersion of the guide elements 13a, 13b, 13c into the grooves 32 in the non-heated condition. By this means, it is guaranteed that, because of the thermal expansion of the rotor 12, a jamming-free running clearance of the guide elements 13a-c in the grooves is always maintained.

The three guide elements 13a, 13b, 13c are distributed at a uniform angular distance, preferably along the external circumference (or also along the internal circumference, if applicable; see in this connection, by way of example, one of three guide elements 13d on the inner area of the stator 33) of the rotor 12, for which grooves 32 are provided in the wall of the stator 1. By this means, a precise, jamming-free guidance of the end of the rotor 12 located at a distance from the gas exchange valve 11 is brought about in the stator 1.

Furthermore, the internal current coil 23 attached within the stator 1, which is guided in a clearance-free manner within the internal space of the stator 33, as well as the stator core 15 positioned in the internal space of the stator 33, which stator core is penetrated in its center by a stator boring 14, is shown in FIG. 4a.

FIG. 4d elucidates, in a spatial representation, the tubular construction of the rotor 12 with the three guide elements 13a, 13b, 13c integrally formed with the external circumference of the rotor, which guide elements extend at least partially over the entire height of the rotor. The rotor bars 19 which, in accordance with FIG. 3, extend into the bushings 8 in the base frame 9 of the stator 1, can be seen on the lower end of the rotor 12.

FIG. 4c illustrates, in a spatial representation, the tubular construction of the rotor 12 with the three guide elements 13d, which are integrally formed with the internal circumference of the rotor and which engage in the grooves 32 of the internal area of the stator 33, which area is located outside the current coil 23.

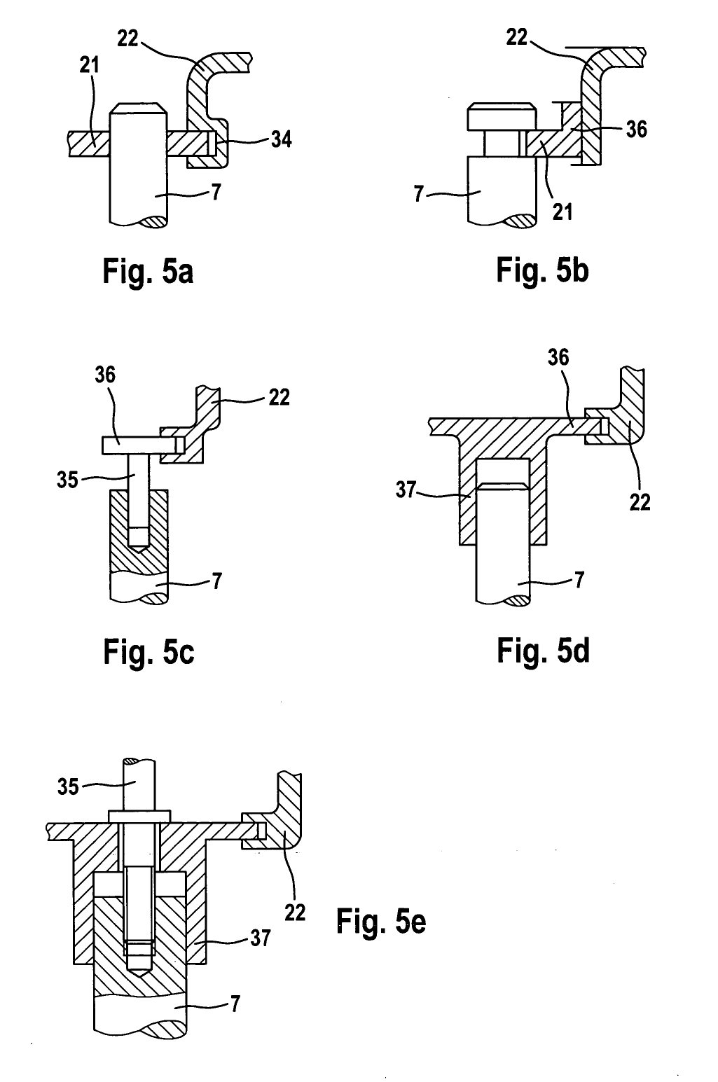

Referring to the coupling element 22 depicted in FIG. 1, several examples of implementation, which will be described in further detail in the following, are depicted in FIGS. 5a-5e.

FIG. 5a depicts a first form of construction of the coupling element 22, in the form of a clamping ring 21, which ring encompasses, in its internal area, the valve stem 7 of the gas exchange valve 11 in a force-locking manner. The external area of the clamping ring 21 is, on the other hand, accommodated by the coupling element 22, for which the coupling element 22 is provided with a hollow cylinder and an annular groove 34 located in the same, or with a tubular section formed as a gripping device, within which tubular section the clamping ring 21 is fixed.

FIG. 5b depicts, in modification of the clamping ring 21 in accordance with FIG. 5a, the engagement of a clamping ring 21 provided with a band in a groove of the valve stem 7.

FIG. 5c discloses a clamping pin 35, which is pressed into a blind hole aperture of the valve stem 7, whereby the end of the clamping pin 35 is provided with a band 36, which is encompassed by the casing of the coupling element 22.

The use of a collet 37, rather than a clamping pin 35, is proposed in FIG. 5d, which collet engages with the casing of the coupling element 22 by way of a band 36.

Finally, in FIG. 5e, the collet 37 in accordance with FIG. 5d is supplemented by an adjusting device 38, whereas an adjustment screw projects into a threaded blind boring of the valve stem 7 through the collet 37, so that tightening can be carried out by rotating the adjusting screw of the valve stem 7 into the collet 37 to greater or lesser depths.

The connection techniques presented in FIGS. 5a-5e can obviously be multiply combined with force-locking, form-locking, and/or homogeneously bonded connection variants, in accordance with wish or need.

The valve drive proposed in accordance with the invention is distinguished, in a summary manner, by the following characteristics:
1. An easily joinable and separable function groups [sic: “an” . . . “groups”] consisting of the stator 1 with the rotor 12, the coupling element 22, and the gas exchange valve 11.
2. The placement of bushings 8 distributed over the circumference of the base frame 9 (first end area of the stator 1). The losses in the magnetic circuit are thereby reduced by several magnitudes, since the magnetic circuit is not closed in this area only by means of a large, circularly rotating air gap, as was previously the case, but instead by means of magnetically well-conducting bars 20.
3. The simple balancing of the manufacturing tolerances between the stator 1, rotor 12, cylinder head 2, and gas exchange valve 11 in the direction of the longitudinal axis of the valve drive and of the gas exchange valve 11 by means of a surprisingly simple coupling connection and valve adjustment through the fact that, with reference to the depiction in accordance with FIG. 1, a valve closing force F holds the gas exchange valve 11 on the valve seating ring 16, and an adjusting pin 39 (in the case of a stator 1 mounted in the cylinder head 2), which acts on the coupling element 22 through the stator boring 14, produces a force through the coupling element 22 formed on the rotor 12 which positions the rotor 12 in the same position in relation to the stator 1.
4. An alternative adjustment by means of an adjustment screw is already known from FIG. 5e.
5. A simple, tolerance-balancing effect through the auxiliary spring 26 positioned between the valve drive and the gas exchange valve 11.
6. A guiding of the rotor 12, independently of the thermally-induced changes in diameter, whereby changes in diameter between the rotor 12 and the stator 1 have no influence on the guidance. Through the use of the guide elements 13 a-c proposed for this, the rotor 12 is securely guided and supported, even in a critical air gap area, against the high magnetic transverse forces acting there, as well as against the transverse acceleration forces. The number of guide elements used for this can vary between two and a larger multiple.
7. Large permissible manufacturing tolerances for the individual parts, and thereby reasonably priced manufacturing of the valve drive.
8. Simple mounting of all parts of the valve drive in the cylinder head 2.
9. Simple service in workshop operation.
10. The auxiliary spring 26 prevents the valve disk from coming into contact with the piston of the internal combustion engine and thereby being destroyed.
11. The invention proposed consequently guarantees:
   Economic manufacturing tolerances;
12.—Economic mounting and automatic adjustment of the valve drive;
   Low losses in the magnetic circuit;
13.—High efficiency, since it is optimally adjustable and has low frictional forces;
14.—Thermally stable, even during the run-up phase and the cooling phase of the engine;
   Simple workshop service;
   Adjustable upon high valve abrasion.

It should be taken into account, finally, that the invention proposed is not restricted to the examples of implementation illustrated here, but instead offers multiple possibilities for use, independently of whether the magnetic rotor 12 is a component of a linear motor, of a magnetic drive in the form of one or more serially positioned electromagnets, or of a piezodrive.

### LIST OF REFERENCES

1 Stator
2 Cylinder head
3 Valve accommodation boring
4 Gas exchange valve
5 Intake channel
6 Outlet channel
7 Valve stem
8 Bushing
9 Base frame
10 Spacing part
11 Gas exchange valve
12 Rotor
13a Guide element
13b Guide element
13c Guide element
14 Stator boring
15 Stator core
16 Valve seat ring
17 Camshaft
18 Tappet
19 Rotor bar
20 Connecting bar
21 Clamping ring
22 Coupling element
23 Current coil
24 Cavity
25 Gradated boring
26 Auxiliary spring
27 Cover
28 Current coil chamber
29 Magnetic ring
30 Tooth area
31 Connecting frame
32 Groove
33 Internal area of stator
34 Annular groove
35 Clamping pin
36 Band
37 Collet
38 Adjusting device
39 Adjusting pin

1-8. (canceled)

9. A valve drive for a gas exchange valve in a power engine comprising:
a stator having a current coil;
a magnetic rotor which extends in a longitudinally movable manner and having a rotor section which is positioned at a distance from the gas exchange valve within the stator, so that one end of the rotor projects out from the stator, upon the stimulation of the current coil, activates the gas exchange valve, wherein the rotor (12) in combination with the stator (1) form a structural component which is independently operable, can be inspected in advance, and which is detachably connected with the gas exchange valve (11).

10. The valve drive according to claim 9 further comprising:
two or more bushings (8), through which several rotor bars (19) positioned on the rotor (12) extend, are provided in a first area of the stator (1), wherein the firs area is oriented towards the gas exchange valve (11).

11. The valve drive according to claim 10, wherein the bushings (8) and the rotor bars (19) are positioned distributed at a uniform angular spacing over the circumference of the stator (1).

12. The valve drive according to claim 11, the bushings (8) provided for the rotor bars (19) are spaced from one another by several connecting bars (20) of the stator (1) conducting the magnetic flux, whereby a cross-sectional surface of every connecting bar (20) is significantly larger than the cross-section of an aperture of every bushing (8).

13. The valve drive according to claim 10, wherein a second area of the stator (1), which is positioned oriented away from the first area of the stator (1), engages with several guide elements (13a, 13b, 13c, 13d) attached to the external or the internal circumference of the rotor (12), for which the guide elements (13a, 13b, 13c, 13d) are positioned movably in several grooves (32) of the stator (1), which are positioned distributed radially over the external or the internal circumference of the stator (1).

14. The valve drive according to claim 13, wherein the guide elements (13a, 13b, 13c, 13d) enter into the grooves (32) of the stator (1) at a uniform angular distance along the internal or the external circumference of the stator (1), whereby, in order to balance the manufacturing- or the thermal expansion tolerances of the components, the depth of the groove is selected to be greater than the immersion depth of the guide elements in the operation of the rotor (12).

15. The valve drive according to claim 9, wherein a coupling element (22) is positioned between the rotor (12) and the gas exchange valve (11), wherein the coupling element produces a force-locking and/or form-locking connection between the rotor (12) and the gas exchange valve (11).

16. The drive valve according to claim 15, wherein the coupling element (22) is provided with a catching—and/or clamping mechanism, which is preferably designed as a catching hook or clamping ring (21).
